(19) United States
(12) Patent Application Publication
(10) Pub. No.: US 2012/0018181 A1
(43) Pub. Date: Jan. 26, 2012

(54) Output Mode Switching Device For Power Tool

(75) Inventor: Ting-Kuang Chen, Keelung City (TW)

(73) Assignee: TOP GEARBOX INDUSTRY CO., LTD., TAOYUAN COUNTY (TW)

(21) Appl. No.: 13/032,606

(22) Filed: Feb. 22, 2011

(30) Foreign Application Priority Data
Jul. 23, 2010 (TW) 099214108

(51) Int. Cl. B25F 5/00

(52) U.S. Cl. 173/47

(57) ABSTRACT

An output mode switching device includes an output unit, a stationary ratchet gear unit, a spring, at least one block, a case for accommodating the parts mentioned above, and a control device threadedly connected to the case. The output unit includes an output shaft and a first bearing and a movable ratchet gear connected thereto. Movable ratchet teeth of the movable ratchet gear face stationary ratchet teeth of the stationary ratchet gear. The stationary ratchet gear has circumferential ribs and the block has an inner protrusion and an outer protrusion. Two ends of the spring respectively contact with the first bearing and the inner protrusion of the block. The control device is operated to allow the inner protrusion to be engaged with or separated from the rib of the stationary ratchet gear. Therefore the output shaft outputs torque without axial vibration or with axial vibration.

### BACKGROUND OF THE INVENTION

1. Field of the Invention

The present invention relates generally to a power tool, and more particularly, to An output mode switching device for a power tool to smoothly switch into output modes of pure rotation and rotation combined with axial vibration.

2. The Prior Arts

A conventional power tool, such as a power drill, generally outputs power from the motor to the output shaft by the gear unit. Besides, in order to tighten or loosen the bolts, some power tools are equipped with an axial vibration function which can output an impact force to tighten or loosen the bolts.

The conventional impact power tool with the vibration function generally comprises an output shaft, a stationary ratchet gear and a movable ratchet gear mounted to the output shaft, at least one block located between the stationary ratchet gear and the movable ratchet gear, a case for accommodating the parts mentioned above, and an adjusting knob which is threadedly connected to the case. The stationary ratchet gear is cooperated with a bearing and located within the case and is rotatable relative to the case. The movable ratchet gear is fixed to the output shaft and is co-rotated with the output shaft. When the adjusting knob is rotated in the forward direction or the reverse direction, the block is controlled to move axially toward the front end or the rear end of the case so as to control the protrusions on the block to be engaged with or disengaged from the ribs on the stationary ratchet gear. When the protrusions are not engaged with the ribs and the output shaft is applied by an axial force to engage the movable ratchet gear with the stationary ratchet gear, because the stationary ratchet gear is free to rotate, the output shaft driven by the power source device provides the output in the form of pure rotation. When the protrusions are engaged with the ribs and the output shaft is applied by the axial force to engage the movable ratchet gear with the stationary ratchet gear, because the stationary gear is fixed, so that the power source device drives the output shaft to rotate and the ratchet teeth on the movable ratchet gear are forced to move over the ratchet teeth on the stationary ratchet gear. By the interference, the output shaft outputs axial vibration.

The shortcomings of the conventional switching device is that when the protrusions of the block are moved to be engaged with the ribs of the stationary ratchet gear, the protrusion is not precisely aligned with the gap between the ribs so that the protrusion can not engaged with the ribs. Thus, the users have to re-adjust the output unit to an idle state, and then adjust the adjusting knob until the protrusions of the block are engaged with the ribs. It is inconvenient for the users.

### SUMMARY OF THE INVENTION

A primary objective of the present invention is to provide an output mode switching device for a power tool which overcomes the shortcomings of conventional designs. The output mode switching device can smoothly switch between the mode of pure rotation and the mode of rotation combined with vibration.

The characteristic of the present invention is to provide a spring which provides a consistent force to a block of the output mode switching device so that a protrusion of the block is consistently pressed against a side of a rib of a stationary ratchet gear. When a knob is rotated to control the block to engage with the ribs of the stationary ratchet gear, the protrusions of the blocks can easily engaged with the stationary ratchet gear so as to switch the different output modes of the power tool.

The present invention provides an output mode switching device that includes an output unit, a stationary ratchet gear unit having a second bearing, a spring disposed between the output shaft unit and the stationary ratchet gear unit, at least one block, a case for accommodating the parts mentioned above, and a control device threadedly connected to the case. The output unit includes an output shaft, and a first bearing and a movable ratchet gear connected thereto. Movable ratchet teeth of the movable ratchet gear face stationary ratchet teeth of the stationary ratchet gear. The stationary ratchet gear has multiple ribs disposed at a circumferential surface. The block has an inner protrusion and an outer protrusion. Two ends of the spring contact with the first bearing and the inner protrusion of the block, respectively. When the inner protrusion of the block is not engaged with the rib of the stationary ratchet gear and the movable ratchet teeth are engaged with the stationary ratchet gear, the output shaft outputs pure rotation. When the control device is operated to engage the inner protrusion of the block with the rib of the stationary ratchet gear and the movable ratchet teeth are engaged with the stationary ratchet teeth, the movable ratchet teeth is forced to move over the stationary ratchet teeth. Due to interference between the movable ratchet teeth and the stationary ratchet teeth, the output shaft outputs rotation combined with axial vibration.

The output mode switching device is preferred to include two symmetric blocks which are facing to each other.

The block having the inner protrusion and the outer protrusion is preferred to be integrally formed, and the inner protrusion and the outer protrusion are bent from the block.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view to show an output mode switching device for a power tool in accordance with the present invention;

FIG. 2 is a perspective view having a quarter section removed to show the inside of the output mode switching device according to the present invention, wherein the output mode switching device is switched to be a mode of pure rotation;

FIG. 3 is a perspective view having a quarter section removed to show the inside of the output mode switching device according to the present invention, wherein the output mode switching device is switched to be a mode of rotation combined with vibration; and

FIG. 4 is a perspective view having a quarter section removed to show the inside of the output mode switching device according to the present invention, wherein a protrusion of a block is pressed against a side of a rib of a stationary ratchet gear and cannot be moved.

### DETAILED DESCRIPTION OF THE PREFERRED EMBODIMENT

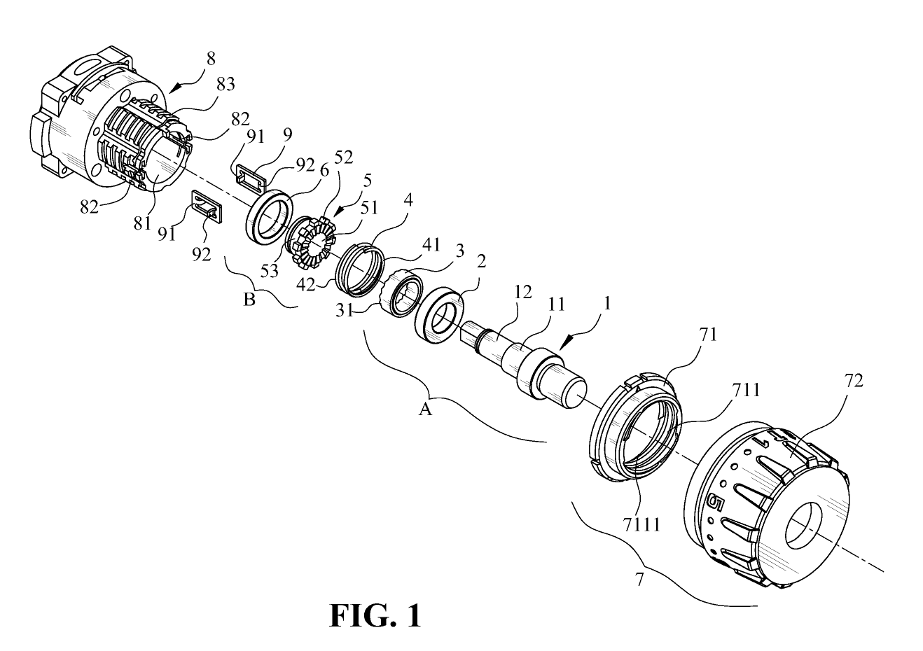

With reference to the drawings and in particular to FIG. 1, an output mode switching device for a power tool in accordance with the present invention comprises an output unit “A”, a stationary ratchet gear unit “B”, a spring 4, two blocks 9, a case 8 and a control unit 7. The output unit “A” comprises an output shaft 1, a first bearing 2 and a movable ratchet gear 3. The output shaft 1 includes multiple sections with different diameters and the sections include a first section 11 having a larger diameter and a second section 12 having a smaller diameter. The first bearing 2 is securely mounted to the first section 11 and the stationary ratchet gear 3 is securely mounted to the second section 12. The movable ratchet gear 3 includes a plurality of movable ratchet teeth 31 on a side surface thereof.

The stationary ratchet gear unit “B” has a stationary ratchet gear 5 and a second bearing 6. The stationary ratchet gear 5 includes a tubular body 53, a plurality of stationary ratchet teeth 51 extending from a side surface of the tubular body 53 and a plurality of ribs 52 extend radially from a circumferential surface of the tubular body 53. The stationary ratchet gear 5 has a central hole 50 through which the output shaft 1 passes. The second bearing 6 is securely connected to the tubular body 53 of the stationary ratchet gear 5.

The block 9 according to a preferred embodiment has an inner protrusion 91 on one end thereof and an outer protrusion 92 on another end thereof.

The case 8 has a space 81 in which all of the parts mentioned above are received. The first bearing 2 and the second bearing 6 are connected to an inside of the space 81. Two grooves 82 are axially defined in an inside surface of the case 8 and face each other. The case 8 has outer threads 83 defined in an outside surface thereof.

The control unit 7 includes a knob 72 and a nut 71 connected to an inner surface of the knob 72. The nut 71 has inner threads 711 to be threadedly connected to the outer threads 83 of the case 8. The inner threads 711 have a threaded end surface 7111 which are engaged with the outer protrusions 92 of the blocks 9.

When assembling, the first bearing 2 and the movable ratchet gear 3 are respectively mounted to the first and second sections 11, 12 of the output shaft 1 so as to form the output unit “A”. The spring 4 and the stationary ratchet gear unit “B” are then connected to the output shaft 1 so that a first end 41 of the spring 4 is in contact with the first bearing 2 and a second end 42 of the spring 4 is in contact with the inner protrusion 91 of the block 9. The two blocks 9 are slidably engaged with the grooves 82 in the case 8. The output unit “A”, the spring 4 and the stationary ratchet gear unit 5 are then assembled in the space 81 of the case 8. An end of the output shaft 1 is connected to a power source (not shown in drawings) at a rear end of the case 8. The power source includes a motor and a gear unit. When the motor is in operation, the output shaft 1 is driven to rotate through the gear unit. The knob 72 connected with the nut 71 is threadedly connected to the outer threads of the case 8.

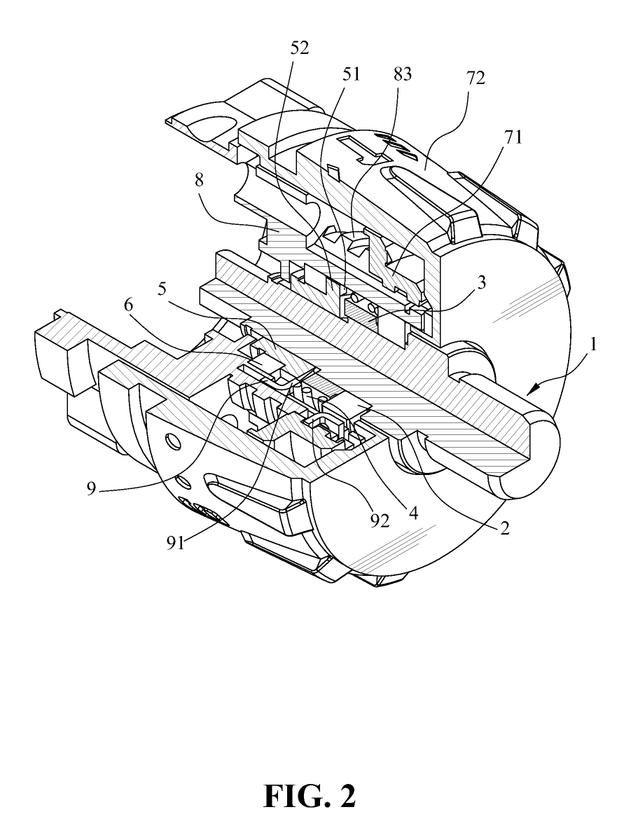

As shown in FIG. 2, the knob 72 is rotated to a first position where the threaded end surface 7111 support the outer protrusions 92 of the blocks 9. When the power source drives the output shaft 1 to rotate and an axial force is applied onto the output shaft 1 toward the case 8, the movable ratchet teeth 31 of the movable ratchet gear 3 are engaged with the stationary ratchet teeth 51 of the stationary ratchet gear 5. Because the stationary ratchet gear 5 is connected to the second bearing 6 and the second bearing 6 is not fixed, the stationary ratchet gear 5 is driven by the movable ratchet gear 3 and the stationary ratchet gear 5 is co-rotated with the output shaft 1. In other words, the output shaft 1 output torque in the mode of pure rotation.

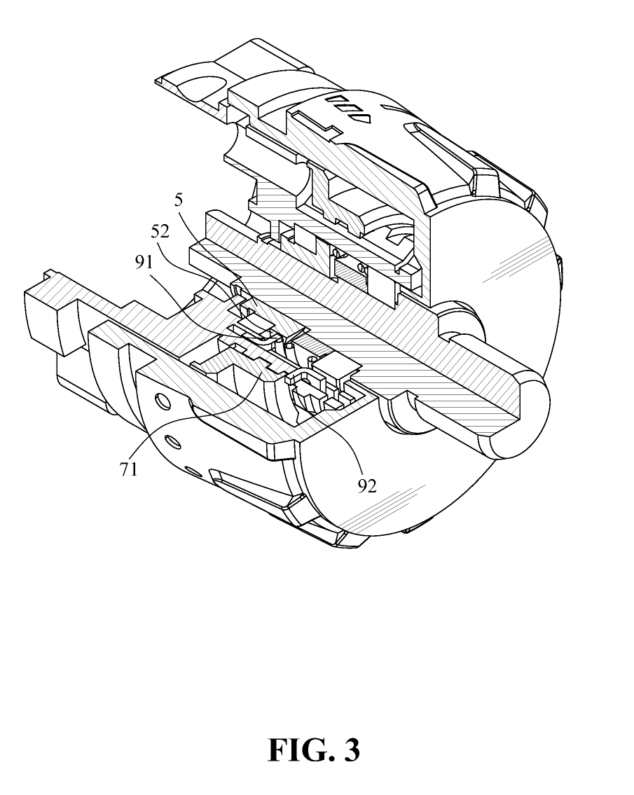

As shown in FIG. 3, the knob 72 is rotated to a second position where the threaded end surface 7111 is disengaged from the outer protrusions 92 of the blocks 9. The second end 42 of the spring 4 applies a force to the inner protrusions 91 of the blocks so that the inner protrusions 91 are engaged with the ribs 52 of the stationary ratchet gear 5. When the power source drives the output shaft 1 to rotate and an axial force is applied onto the output shaft 1 toward the case 8, the movable ratchet teeth 31 of the movable ratchet gear 3 are engaged with the stationary ratchet teeth 51 of the stationary ratchet gear 5. Because the stationary ratchet gear 5 is stopped by the blocks 9, the stationary ratchet gear 5 cannot be driven to rotate. Due to interference between the movable ratchet gear 31 and the stationary ratchet gear 51, the output shaft 1 outputs torque in the mode pure rotation combined with axial vibration.

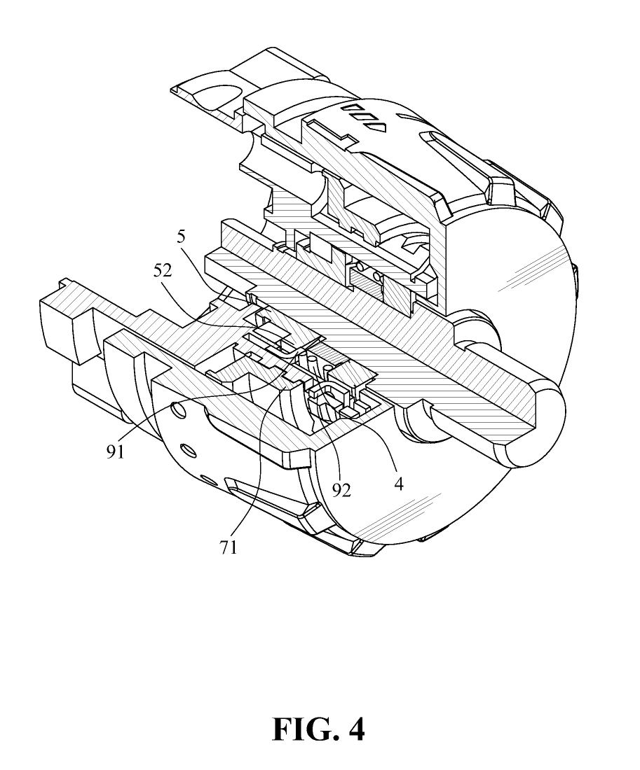

The advantages of the output mode switching device according to the present invention is that when the threaded end surface 7111 of the nut 71 is not engaged with the outer protrusions 92 of the blocks 9, the second end 42 of the spring 4 consistently applies a force to the inner protrusions 91 of the blocks 9, so that the inner protrusions 91 are in contact with the sides of the ribs 52 of the stationary ratchet gear 5 as shown in FIG. 4. The stationary ratchet gear 5 is not fixed and is rotatable when the output shaft 1 starts to rotate. The rotation of the nut 71 is not interfered by other parts and can reach the desired position. Therefore, the inner protrusions 91 of the blocks 9 can be smoothly engaged with the ribs 52 to achieve the switch purpose.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An output mode switching device for a power tool, comprising:
an output unit having an output shaft, a first bearing and a movable ratchet gear connected to the output shaft, the movable ratchet gear having a plurality of movable ratchet teeth on an side surface thereof;
a spring mounted to the output shaft;
a stationary ratchet gear unit having a stationary ratchet gear and a second bearing connected to the stationary ratchet gear, the stationary ratchet gear unit connected to the output shaft, the stationary ratchet gear having a plurality of stationary ratchet teeth extending from a side surface thereof and a plurality of ribs extending radially from a circumferential surface thereof;
at least one block having an inner protrusion and an outer protrusion on two ends thereof;
a case having a space to receive the output unit, the spring, the stationary ratchet gear unit and the block, the first and second bearings being connected to an inside of the space, the case having outer threads defined in an outside thereof and at least one groove defined in the inside thereof corresponding to the block to allow the block to slide along an axial direction of the case; and
a control unit having a knob and a nut connected to the knob, the nut having inner threads which are threadedly connected to the outer threads of the case;
wherein a first end of the spring is in contact with the first bearing and a second end of the spring is in contact with the inner protrusion of the block, the control device is operated to move the nut along an axial direction of the case to engage a threaded end surface of the nut with the outer protrusion of the block or disengage the threaded end surface of the nut from the outer protrusion of the block so as to control whether the inner protrusion of the block is engaged with the rib of the stationary ratchet gear.

2. The device as claimed in claim 1, wherein the device comprises two of the blocks which are disposed facing to each other.

3. The device as claimed in claim 1, wherein the block having the inner protrusion and the outer protrusion is integrally formed.
